(19) United States
(12) Patent Application Publication
(10) Pub. No.: US 2022/0243302 A1
(43) Pub. Date: Aug. 4, 2022

(54) METHOD FOR PROCESSING COPPER AND NICKEL SULFIDE MATERIALS

(71) Applicants: PUBLIC JOINT STOCK COMPANY "MINING AND METALLURGICAL COMPANY "NORILSK NICKEL", Dudinka, Krasnoyarsky krai (RU); JOINT STOCK COMPANY "KOLA GMK", Monchegorsk, Murmanskaya oblast (RU)

(72) Inventors: Boris Eduardovich ZATITSKY, Saint-Petersburg (RU); Vadim Lvovich DUBROVSKY, Monchegorsk, Murmanskaya oblast (RU); Oleg Aleksandrovich KHOMCHENKO, Monchegorsk, Murmanskaya oblast (RU)

(21) Appl. No.: 17/623,812

(22) PCT Filed: Jul. 8, 2020
(86) PCT No.: PCT/RU2020/050152

§ 371 Date: Dec. 29, 2021

(30) Foreign Application Priority Data
Jul. 11, 2019 (RU) 2019121796

(51) Int. Cl. C22B 15/00; C22B 3/00

(52) U.S. Cl. CPC C22B 15/0084; C22B 23/0453; C22B 23/0407; C22B 15/0065

(57) ABSTRACT

A method of processing copper and nickel sulfide materials, including oxidizing torrefaction of a material to obtain cinder, leaching the cinder with a cycling solution, separating a leaching residue, and electro-extraction of copper from a leaching solution. The cinder and particulates generated by the torrefaction are separately leached. The particulates are leached in a cycling copper raffinate together with a separated portion of solution from a cinder processing line, the separated portion consisting of a portion of solution provided to the leaching after electro-extraction of copper. Particulates leaching residue is separated. Copper is extracted by solvent extraction from a particulates leaching solution, followed by separate electro-extraction of copper from a circulating re-extract. Then, a portion of the raffinate is separated to be forwarded to a nickel production process.

### CROSS-REFERENCE TO RELATED APPLICATIONS

The present application is the U.S. National Phase of PCT/RU2020/050152, filed on 8 Jul. 2020, which claims priority to Russian Patent Application No. 2019121796, filed on 11 Jul. 2019, the entire contents of which are incorporated herein by reference.

### BACKGROUND

### Field

The invention relates to the field of non-ferrous metal industry, in particular, to methods for processing copper and nickel sulfide materials, which may be a copper concentrate from flotation converter matte separation or nickel-containing copper matte, in particular, white matte.

### Related Art

A method for producing nickel and a precious metal (PM) concentrate from a copper and nickel matte is known, which includes leaching with a chloride solution, precipitation of copper from the solution to obtain copper sulfide cake, extraction of a PM concentrate and electro-extraction of nickel from the solution, wherein before leaching, converter matte is separated into a sulfide fraction and a metallized fraction, the sulfide fraction being subjected to leaching with a chloride solution with chlorine supply, the precipitation of copper and outputting of the latter into a copper sulfide cake is carried out by adding the metallized fraction, which is obtained by the separation of converter matte, into the pulp obtained by the leaching, the copper sulfide cake is torrefied, the resulting cinder is leached, the solution is sent for electro-extraction of copper, and the PM concentrate and flotation tail are extracted from the residue by flotation, wherein, before electro-extraction of nickel, the solution is purified from iron, zinc, copper and cobalt (Russian Patent No. 2415956). The prior art method has a drawback which consists in technical intricacies of copper production process from materials contaminated with chlorides, high operation costs, and losses due to the processing of the sulfide fraction of nickel matte in the nickel production process after the extraction of the metallized fraction.

The method describes nickel and a PM concentrate production process from a copper and nickel converter matte and is not a method for copper production. Therefore, the method does not disclose the specificities of copper production process, in particular, processing copper solutions contaminated by impurities (these are disclosed, in particular, in the closest prior art). The aforementioned drawbacks of the method are stipulated by the fact that it includes processing a combination of copper and nickel sulfide components, as well as the metallized fraction of converter matte in nickel production process using chlorine and chloride solutions. As such, copper sulfide cake, which is taken out from the nickel production process, contains all copper of the copper sulfide component and the greater amount of the PM from among the converter matte, the former residing mostly in its metallized component. The bulk of the PM from among the converter amount is supplied into the copper production process with the sulfide copper cake, as well as impurities consisting of nickel and incompletely removed chlorides, which are proportional to the amount of the copper cake. Chlorides are mainly converted into torrefaction gases and cause corrosion in torrefaction gas processing systems. Leftover chlorides in the cinder make their way into copper electrolyte and hamper the copper production by electro-extraction.

Large amounts of nickel returned with the sulfide copper cake into the nickel production process via the copper production process increase losses, financial and operation costs. PM recovery via float concentrate extracted from the leaching residue in the copper production process leads to increased losses and incomplete production process of PMs. Hence, when magnetic fraction is extracted from the copper and nickel converter matte, copper and nickel sulfide concentrates are concurrently extracted from the same, to be separately processed.

A method for copper and nickel extraction from sulfide minerals is also known, which includes the steps of torrefying, preferably to obtain magnetite and copper sulfates, e.g., using sulfuric acid, sulfur trioxide, metal sulfate, and/or sulfur dioxide combined with oxygen; then, leaching sulfated cinder and extracting copper from the leaching solution, e.g., by electro-extraction. Copper is mainly dissolved by leaching, but nickel and iron are only partly dissolved. After copper extraction, nickel containing solution is sent back to the torrefaction step, thus the whole amount of nickel is taken out into the leaching residue, which is further transformed into an alloy which contains iron, copper, and nickel (U.S. Pat. No. 4,585,477). The prior art method has a drawback which consists in an intricate scheme of torrefaction and complicated refining of torrefaction gases stipulated by torrefaction treatment of sulfate solutions together with the initial raw materials, amount of the former being proportional to the amount of sulfates obtained by the torrefaction.

The closest prior art for the claimed method in terms of the combination of features and the achieved result is a method for refining copper concentrate from the flotation separation of converter matte (Russian Patent No. 2341573), the method including oxidizing torrefaction of copper concentrate, leaching copper cinder in circulating electrolyte, separating leaching residue, electro-extraction of copper from leaching solutions. As such, the leaching residue in the form of a thick pulp is subjected to flotation separation with extraction of PM concentrate and flotation tail, which mainly contains non-ferrous metals, and which is converted into secondary converter matte, and part of the electrolyte is separated after the electro-extraction of copper and subjected to boiling-down to achieve sulfur acid concentration of 250-300 g/l, copper sulfate is extracted from the latter by crystallization and sulfur acid by extraction, these two being sent back to copper cinder leaching, wherein, after acid extraction, raffinate, which mainly contains nickel, is forwarded into a nickel production process, and PM concentrate is sent to a refining process. The prior art method has such drawbacks as mediocre performance characteristics of the process and relatively low level of direct copper extraction into marketable products.

### SUMMARY

### Technical Problem

The present invention is directed to providing a method for processing copper and nickel sulfide materials and extracting non-ferrous and precious metals.

An object of the claimed invention consists in increased direct extraction of copper.

### Means for Solving the Problem

### Advantageous Effects of Invention

Technical result achieved by the present invention consists in improving performance characteristics of copper and nickel sulfide materials processing, in particular, increasing direct extraction of copper into marketable product, reducing losses of copper and other valuable components, and reducing incomplete processing of non-ferrous and precious metals by reducing process cycles.

The above-mentioned technical result is achieved by virtue of the method for processing copper and nickel sulfide materials including oxidizing torrefaction of material to obtain cinder, leaching the cinder with cycling solution, separating the leaching residue, electro-extraction of copper from the leaching solution, wherein, according to the method, the cinder and particulates generated by the torrefaction are separately leached, wherein the particulates are leached in a cycling copper raffinate together with the separated portion of solution from the cinder processing line, said portion consisting of a portion of solution provided to the leaching after electro-extraction of copper, separating a residue from particulate leaching, extracting copper from the solution from particulate leaching by solvent extraction, with subsequent separate electro-extraction of copper from circulating re-extract, then separating a portion of raffinate to be sent to a nickel production process.

According to the method, a portion of solution after electro-extraction of copper or a master solution from crystallization of a portion of cinder leaching solution is used as the separated portion of the cinder processing line.

According to the method, copper concentrate from flotation separation of converter matte or nickel containing copper matte, in particular, white matte, is used as copper and nickel sulfide materials to be processed.

In the claimed method, copper is produced in two separate lines, wherein the first line, which includes torrefaction and cinder processing, is intended for producing marketable copper using a known scheme of torrefaction, leaching, and electro-extraction, and the second line, which includes processing particulates from the torrefaction, is intended for producing marketable copper using a known scheme of leaching, solvent extraction, and electro-extraction.

The process of torrefying a raw material (copper concentrate from flotation separation of converter matte or nickel containing copper matte, in particular, white matte) is associated with significant particulate entrainment, which may amount up to 60% when a fluidized layer furnace is used. For this reason, the fluidized layer furnace is provided with a multiple-stage particulate collecting system. Particulates from the particulate collecting system are sent back to the furnace for torrefaction or are forwarded to further processing together with cinder. Output of particulates and their characteristics are defined by hardware implementation of the torrefaction, its conditions, and fineness (particle size) of the initial sulfide material. It is not expedient to send fine particulates, whose output is defined by hardware implementation and conditions of torrefaction, back to the torrefaction, since they will again promptly leave the torrefaction chamber.

Advantages of the claimed method are based on the fact that fine particulates from last stages of particulate collecting system are an incompletely torrefied material, hence the level of impurities transfer into the solution from the particulates is significantly higher than from the cinder. Besides, fine particulates from the last stages of particulate collection are further enriched with the most harmful volatile trace impurities. Taking into account that fine particulates from the torrefaction of copper containing materials are the source of most impurity elements which contaminate copper, such as nickel, iron, and trace impurities, such as selenium, tellurium, arsenic, the separate leaching of cinder and fine particulates from the torrefaction in distinct process lines, and producing marketable copper from fine particulate leaching solutions via selective extraction of copper, would prevent the marketable copper from being contaminated with impurities and would provide for its consistent high quality.

It is not mentioned in the closest prior art method but is apparent for a person skilled in the art that cinder and particulates from the torrefaction are processed together, which causes additional contamination of copper production process solutions with impurities. In the claimed invention, impurities are much slower accumulated in the cinder processing line without fine particulates. To keep impurities content at allowable level, a portion of electrolyte is separated for recycling, thus, in the claimed invention, the amount of cinder processing line solution portion which is separated based on the dominating impurity from among the possible ones, such as nickel, iron, selenium, tellurium, arsenic etc., is smaller than in the case of leaching fine particulates and cinder together, as done in the closest prior art.

In the case of separate processing of fine particulates by the claimed method of leaching—extraction—electro-extraction, contamination of marketable copper with impurities in the particulate processing line is hindered by selective extraction of copper, which provides for a high allowable content of impurities in the processed solution. A ratio of impurities to copper in the separated portion of raffinate appears to be significantly higher than without the selective extraction.

Additional novelty and utility of the method is stipulated by forwarding only a portion of copper depleted raffinate to the nickel production process, which significantly reduces the amount of copper which is forwarded to the nickel production process. This is explained by the fact that the portion of copper enriched solution from the cinder processing line, which is separated based on the dominating impurity, is not taken out for further processing, but is forwarded to particulate leaching together with cycling raffinate. After the extraction, copper content in the raffinate becomes low, thus the raffinate portion, which is separated for forwarding to the nickel production process, contains a small amount of copper—1.5-2.0 g/l. This increases the ratio of impurities to copper in the solution that is separated for the nickel production process, and direct extraction of copper is increased, thus losses of the latter with recycling are reduced. Copper extraction is a rather simple standard operation (it is widely known and used) and consumes significantly less energy than the processing of separated portion of the solution as in the closest prior art.

The claimed method for processing of copper and nickel sulfide products provides for producing copper in separate cinder and particulate processing lines, which correspond to their independent operation in optimal modes.

In an optimal embodiment, the amount of copper forwarded into the nickel production process is further reduced by prior crystallization of copper sulfate from the separated portion of solution which circulates through the cinder processing line. The extracted clean copper sulfide is dissolved in circulating solution of the cinder leaching line, and only a master solution from crystallization which is enriched with impurities is forwarded to particulates leaching.

Unlike the closest prior art, rich solution from leaching, which is close to copper solubility limit, and not copper stripped solution after electro-extraction, is sent to crystallization. Then, cooling with minimum boiling-down is sufficient for copper sulfate extraction. This is due to the fact that cooling drastically reduces the solubility of salts. Unlike the closest prior art, extraction of acid from the separated solution is not necessary, and copper is further extracted from the master solution from crystallization in the particulates leaching line. Unlike the closest prior art, energy consumption for boiling-down is reduced, and acid extraction operations are omitted. Unlike the closest prior art, abundance of copper is retained in the master solution from crystallization as compared to the impurities, which results in much purer copper sulfate and reduced partial return of impurities with impure copper sulfate into the main production process. This reduces the amount of solutions to be boiled-off.

Particulates output from the torrefaction of copper sulfide materials is determined by multiple factors, in particular, by properties of the initial material, torrefaction modes, structural specificities of the furnace and of particulate collection systems. In general, particulates output may exceed cinder output. However, a major portion of the particulates is typically returned to the torrefaction, and only a smaller portion of the particulates captured by a fine particulates collection system is rich in harmful impurities, in particular, selenium, tellurium, or more soluble impurities. Solubility of iron and nickel from the particulates is significantly greater than that from the cinder. Typically, output level of such particulates is 5% to 20% of cinder output. It is only expedient to process them in a separate line.

As in the closest prior art, precious metals concentrate may be extracted by a flotation method from the homogenized residue from cinder and particulates leaching, and flotation tail which predominantly includes non-ferrous metals may be processed into converter matte.

The claimed method may be used for processing various sulfide materials, in particular, copper concentrate from flotation separation of converter matte, nickel containing copper matte, or white matte which is a copper matte after pyrometallurgical removal of main portion of iron therefrom (conversion).

### BRIEF DESCRIPTION OF THE DRAWINGS

Simplified schematic process diagrams of sulfide material processing are provided in FIGS. 1 and 2, in which:

FIG. 1 shows a simplified schematic process diagram of an embodiment of the inventive sulfide material processing; and

FIG. 2 shows a simplified schematic process diagram of an optimal embodiment of the inventive sulfide material processing.

### DETAILED DESCRIPTION

Implementation of the Inventive Method.

Implementation of the inventive method for processing copper concentrate from flotation separation of converter matte as the initial material is described. In the same manner, the method may be implemented for nickel containing copper matte, in particular, white matte.

Copper concentrate from flotation separation of converter matte is torrefied in a fluidized layer (FL) furnace at a boiling material layer temperature of 870°−930° C. until the sulfur residue in the cinder is about 0.1%. After filtering out particulates, torrefaction gases are forwarded into a sulfur acid production process. Torrefaction results in cinder and fine particulates enriched up to 2.0% sulfur. Fine particulates output is 15.5% of cinder output.

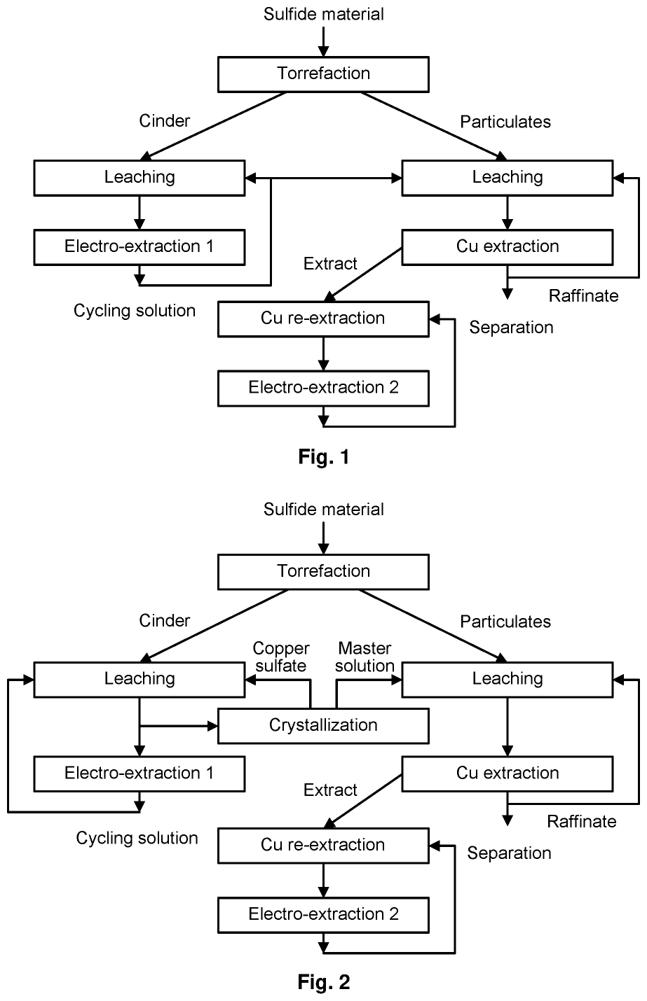

A simplified schematic process diagram of an embodiment of the inventive processing is illustrated in FIG. 1. Two copper production lines are involved in the method: electro-extraction 1 from cinder and electro-extraction 2 from particulates.

The cinder is leached in a circulating solution of the cinder processing line, i.e., solution after copper electro-extraction 1. Residue from cinder leaching is condensed and forwarded to water flushing and flotation together with residue from particulates leaching. After postfiltration, cinder leaching solution is sent to copper electro-extraction 1. Baths are supplied with electrolyte which is obtained by homogenization of postfiltration filter liquid and electrolyte which is recovered from the baths. Marketable copper is produced in baths with lead-based alloy anodes. Part of acid electrolyte recovered from the baths is mixed with postfiltration filter liquid, part is returned into cinder leaching, and part is separated for particulates leaching.

Particulates from torrefaction are leached in a portion of copper extraction raffinate together with a separated portion of electrolyte from copper electro-extraction 1. Residue from particulates leaching is condensed and forwarded to water flushing and flotation together with the residue from cinder leaching. Postfiltration filter liquid from the particulates leaching solution is forwarded to copper extraction by solvent extraction. The extraction is carried out using a modified oxyoxime based extractant (Acorga M5640 produced by Cytec InD, or its equivalent) with 30 vol. % concentration in the form of a solution in a carbohydrate diluter. Raffinate after copper extraction is returned to particulates leaching, and a portion of the raffinate is separated from the copper production process and forwarded into a nickel production process. Copper re-extraction is carried out using the portion of electrolyte which is recovered from the baths of the separate copper electro-extraction 2 line. Re-extraction product is homogenized with the portion of electrolyte recovered from the separate copper electro-extraction 2 line and is supplied to the copper electro-extraction 2 baths. Marketable copper is produced in baths with lead-based alloy anodes. A portion of acid electrolyte recovered from the baths is mixed with the re-extraction product, and another portion is forwarded back to copper re-extraction.

PM concentrate is extracted using a flotation method from pulp which results from combined flushing of residues from cinder and particulates leaching. Flotation tails are forwarded into a secondary converter matte production process.

In an optimal embodiment, the claimed method further includes boiling down and crystallization of copper sulfate from a portion of cinder leaching solutions. As such, it is not the separated portion of electrolyte recovered from copper electro-extraction 1 baths but a master solution from copper sulfate crystallization that is sent to particulates leaching.

A simplified schematic process diagram of an optimal embodiment of the inventive processing of copper concentrate from flotation separation of converter matte is illustrated in FIG. 2. The method also involves two copper production process lines: electro-extraction 1 from cinder and electro-extraction 2 from particulates.

The cinder is leached in a circulating solution of the cinder processing line, i.e., solution after copper electro-extraction 1. Residue from cinder leaching is condensed and forwarded to water flushing and flotation together with residue from particulates leaching. After postfiltration, the bulk of the cinder leaching solution is sent to copper electro-extraction 1. A portion of leaching solution after postfiltration, which amounts to 3.5%-4%, is sent to vacuum boiling-down and crystallization of copper sulfate, which is performed at room temperature. Crystallization results in a master solution which is sent to particulates leaching, and in copper sulfate crystals to be dissolved, and the solution is combined with the solution which is sent to postfiltration. Baths are supplied with electrolyte which is obtained by homogenization of postfiltration filter liquid and electrolyte which is recovered from the baths. Marketable copper is produced in baths with lead-based alloy anodes. Part of acid electrolyte recovered from the baths is mixed with postfiltration filter liquid, and another part is returned to cinder leaching.

Particulates from torrefaction are leached in a portion of raffinate from copper extraction together with the master solution from copper sulfate crystallization. Residue from particulates leaching is condensed and forwarded to water flushing and flotation together with the residue from cinder leaching. Postfiltration filter liquid from the particulates leaching solution is forwarded to copper extraction by solvent extraction. The extraction is carried out using a modified oxyoxime based extractant (Acorga M5640 produced by Cytec InD, or its equivalent) with 30 vol. % concentration in the form of a solution in a carbohydrate diluter. Raffinate after copper extraction is returned to particulates leaching, and a portion of the raffinate is separated from the copper production process and forwarded into a nickel production process. Copper re-extraction is carried out using the portion of electrolyte which is recovered from the baths of the separate copper electro-extraction 2 line. Re-extraction product is homogenized with the portion of electrolyte recovered from the separate copper electro-extraction 2 line and is supplied to the copper electro-extraction 2 baths. Marketable copper is produced in baths with lead-based alloy anodes. A portion of acid electrolyte recovered from the baths is mixed with the re-extraction product, and another portion is forwarded back to copper re-extraction.

### EXAMPLES

### Example 1. Implementation of the Closest Prior Art Method

Copper concentrate from flotation separation of converter matte, which contains, in %: Cu—70.7; Ni—3.9; Fe—3.9; S—21.0, is torrefied in a fluidized layer (FL) furnace at a fluidized material layer temperature of 870°−930° C. until sulfur residue content in the cinder is 0.1%. After filtering out particulates, torrefaction gases are forwarded into a sulfur acid production process. Torrefaction results in cinder with the following composition, %: Cu—71.3; Ni—3.9; Fe—3.9; and fine particulates enriched up to 2.0% sulfur, with the following composition, %: Cu—68.7; Ni—4.4; Fe—4.4. Fine particulates output is 15.5% of cinder output.

Particulates and cinder are leached together at a temperature of 70°−80° C. in a circulating solution after copper electro-extraction, with the following composition, g/l: Cu—35; H₂SO₄—120. Leaching residue is condensed and sent to water flushing and flotation. After postfiltration, cinder leaching solution, having the following composition, g/l: Cu—100; H₂SO₄—15, is sent to copper electro-extraction. Baths are supplied with electrolyte which is obtained by homogenization of postfiltration filter liquid and electrolyte which is recovered from the baths. Using current density of 270 A/m²-300 A/m², marketable copper is produced in baths with lead-based alloy anodes. Bath supply solution has the following composition, g/l: Cu—40; Ni—20; H₂SO₄—112. In a bath, the solution has the following composition, g/l: Cu—35; Ni—20; H₂SO₄—120. A part of electrolyte, which is recovered from the baths, is mixed with postfiltration filter liquid, a part is returned into cinder leaching, and a part is separated for recycling. The amount of solution which is separated for recycling is determined by the maximum allowable nickel content in circulating solutions, which is 20 g/l, thus amounting to 1.45 m³ per ton of marketable copper. As such, iron content in circulating solutions is 2.4 g/l.

The separated portion of electrolyte recovered from the baths is boiled down by 3 times to reach acid concentration of 360 g/l. Copper sulfate is cooled and crystallized. Copper sulfate is separated from the master solution and forwarded into a cinder leaching line. Sulfur acid is separated from the master solution using solvent extraction. A mixture containing, in vol. %: 30—C7-C9 fraction trialkylamines, and 70—isooctyl alcohol, is used as the extractant. Acid re-extraction is performed using water. Extraction results in a re-extract with the following composition, g/l: Cu—0.4; Ni—2.1; Fe—0.2; H₂SO₄—135, which is returned into cinder leaching, and raffinate with the following composition, g/l: Cu—11.5; Ni—32.5; Fe—3.6; H₂SO₄—157, which is forwarded into a nickel production process. Nickel to copper ratio in the raffinate which is forwarded into a nickel production process is 2.8 t/t.

PM concentrate is extracted from the pulp from flushed cinder and particulates leaching residues using a flotation method. Flotation tails are forwarded into a secondary converter matte production process.

Electro-extraction results in marketable copper, M0k grade copper cathodes according to GOST 546-2001. The copper cathodes do not comply with the highest M00k grade due to selenium content which is standardized to be not higher than 0.00020%. Copper cathodes impurity is caused by increased selenium transfer into the solutions from torrefaction particulates which are rich in selenium.

### Example 2. Implementation of the Inventive Method

Copper concentrate from flotation separation of converter matte, which contains, in %: Cu—70.7; Ni—3.9; Fe—3.9; S—21.0, is torrefied in a fluidized layer (FL) furnace at a fluidized material layer temperature of 870°−930° C. until sulfur residue content in the cinder is 0.1%. After filtering out particulates, torrefaction gases are forwarded into a sulfur acid production process. Torrefaction results in cinder with the following composition, %: Cu—71.3; Ni—3.9; Fe—3.9; and fine particulates enriched up to 2.0% sulfur, with the following composition, %: Cu—68.7; Ni—4.4; Fe—4.4. Fine particulates output is 15.5% of cinder output.

Thus, the initial material and conditions of its torrefaction, as well as amount and quality of cinder and particulates, are the same as in Example 1.

Cinder is leached at a temperature of 70°−80° C. in a circulating solution from cinder processing line, which is the solution from copper electro-extraction 1, with the following composition, g/l: Cu—35; H₂SO₄—120. Residue from cinder leaching is condensed and forwarded to water flushing and flotation together with residue from particulates leaching. After postfiltration, cinder leaching solution, which has following composition, g/l: Cu—100; H₂SO₄—15, is sent to copper electro-extraction 1. Baths are supplied with electrolyte which is obtained by homogenization of postfiltration filter liquid and electrolyte which is recovered from the baths. Marketable copper is produced in baths with lead-based alloy anodes. Bath supply solution has the following composition, g/l: Cu—40; Ni—20.0; H₂SO₄—112. Solution in the bath has the following composition, g/l: Cu—35; Ni—20.0; H₂SO₄—120. A part of acid electrolyte recovered from the baths is mixed with postfiltration filter liquid, a part is returned into cinder leaching, and a part is separated for particulates leaching. The amount of solution separated for particulates leaching was 0.66 m³ per ton of marketable copper produced in the cinder processing line. It is determined by maximum allowable nickel content in solutions which circulate in the cinder processing line, which is 20 g/l. As such, iron content in circulating solutions is 1.4 g/l.

Particulates from torrefaction are leached at a temperature of 70°−80° C. in a portion of raffinate from copper extraction, which has the following composition, g/l: Cu—2; Ni—16; H₂SO₄—50, together with the separated portion of electrolyte from the cinder processing line (copper electro-extraction 1). Residue from particulates leaching is condensed and forwarded to water flushing and flotation together with the residue from cinder leaching. Filter liquid from the postfiltration of solution from particulates leaching, which has the following composition, g/l: Cu—32; Ni—16; H₂SO₄—3.5, is sent to copper extraction by solvent extraction. The extraction is performed in three stages using a modified oxyoxime based extractant (Acorga M5640 produced by Cytec InD, or its equivalent) with 30 vol. % concentration in the form of a solution in a carbohydrate diluter. Raffinate after copper extraction is returned to particulates leaching, and a portion of the raffinate is separated from the copper production process and is forwarded into a nickel production process. Copper re-extraction is carried out in two stages using the portion of electrolyte recovered from the baths of separate copper electro-extraction 2. The resulting re-extract, which has the following composition, g/l: Cu—50; Ni—8; Fe—0.5; H₂SO₄—147, is homogenized with a portion of electrolyte recovered from the baths of separate copper electro-extraction 2 and is supplied to the baths of copper electro-extraction 2. Using current density of 270 A/m²-300 A/m², marketable copper is produced in baths with lead-based alloy anodes. Bath supply solution has the following composition, g/l: Cu—40; Ni—8; Fe—0.5; H₂SO₄—162. Part of the electrolyte recovered from the baths, which has the following composition, g/l: Cu—35; Ni—8; Fe—0.5; H₂SO₄—170, is mixed with the re-extract, and another part is returned into copper re-extraction.

The amount of raffinate to be separated into the nickel production process is determined by consistency of salt content (total sulfates content) in solutions from the particulates processing line. Nickel to copper ratio in the raffinate which is forwarded into the nickel production process is 3.7 t/t.

PM concentrate is extracted using a flotation method from pulp which results from combined flushing of residues from cinder and particulates leaching. Flotation tails are forwarded into a secondary converter matte production process.

Electro-extraction results in marketable copper, M00k grade copper cathodes according to GOST 546-2001.

### Example 3. Implementation of the Inventive Method

In an optimal embodiment, the claimed method further includes boiling down and crystallization of copper sulfate from a portion of cinder leaching solutions. In this case, it is not the portion of electrolyte recovered from the copper electro-extraction 1 baths, but a master solution from copper sulfate crystallization that is sent to the particulates leaching.

The initial material and conditions of its torrefaction, as well as amount and quality of cinder and particulates, are the same as in the Example 1.

The cinder is leached at a temperature of 70°−80° C. in a circulating solution from the cinder processing line, which is the solution from copper electro-extraction 1, which has the following composition, g/l: Cu—35; H₂SO₄—120. Residue from cinder leaching is condensed and forwarded to water flushing and flotation together with residue from particulates leaching. After postfiltration, bulk of the cinder leaching solution, which has the following composition, g/l: Cu—100; H₂SO₄—15, is sent to copper electro-extraction 1. A portion of the leaching solution after postfiltration, in the amount of 0.66 m³ per ton of cathode copper produced in the cinder processing line, is sent to vacuum boiling-down and crystallization of copper sulfate, which is performed at the temperature of 20° C. Crystallization results in a master solution which has the following composition, g/L: Cu—42; Ni—26; Fe—1.8; H₂SO₄—20, which is sent to particulates leaching, and copper sulfate crystals, which are dissolved and combined with the solution which is provided for the postfiltration. Baths are supplied with electrolyte which is obtained by homogenization of postfiltration filter liquid and electrolyte which is recovered from the baths. Using current density of 270 A/m²-300 A/m², marketable copper is produced in baths with lead-based alloy anodes. Bath supply solution has the following composition, g/l: Cu—40; Ni—20.0; H₂SO₄—112. Solution in the bath has the following composition, g/l: Cu—35; Ni—20.0; H₂SO₄—120. A part of electrolyte recovered from the baths is mixed with the leaching solution, and another part is returned for cinder leaching. The amount of solution which is sent for boiling-down is determined by the maximum allowable nickel content in the solutions that circulate in the cinder processing lines, which is 20 g/l. As such, iron content in the circulating solutions was 1.4 g/l.

Particulates from torrefaction are leached at a temperature of 70°−80° C. in a portion of copper extraction raffinate, which has the following composition, g/l: Cu—2; Ni—18; Fe—2.0; H₂SO₄—50, together with the master solution from copper sulfate crystallization. Residue from particulates leaching is condensed and forwarded to water flushing and flotation together with the residue from cinder leaching. Filter liquid from postfiltration of solution from particulates leaching, which has the following composition, g/l: Cu—32; Ni—18; Fe—2.0; H₂SO₄—3.5, is sent into copper extraction by solvent extraction. The extraction is performed in three stages using a modified oxyoxime based extractant (Acorga M5640 produced by Cytec InD., or its equivalent) in the form of a solution in a carbohydrate diluter, having a 30 vol. % concentration. Raffinate after copper extraction is returned to particulates leaching, and a portion of the raffinate is separated from the copper production process and forwarded into a nickel production process. Copper re-extraction is carried out in two stages using the portion of electrolyte recovered from the baths of separate copper electro-extraction 2. The resulting re-extract, which has the following composition, g/l: Cu—50; Ni—8; Fe—0.5; H₂SO₄—147, is homogenized with a portion of electrolyte recovered from the baths of separate copper electro-extraction 2 and is supplied to the baths of copper electro-extraction 2. Using current density of 270 A/m²-300 A/m², marketable copper is produced in baths with lead-based alloy anodes. Bath supply solution has the following composition, g/l: Cu—40; Ni—8; Fe—0.5; H₂SO₄—162. Part of the electrolyte recovered from the baths, which has the following composition, g/l: Cu—35; Ni—8; Fe—0.5; H₂SO₄—170, is mixed with the re-extract, and another part is returned into copper re-extraction. The marketable copper is produced in baths with lead-based alloy insoluble anodes using a current density of 270 A/m²-300 A/m².

The amount of raffinate to be separated into the nickel production process is determined by consistency of salt content (total sulfates content) in solutions from the particulates processing line. Nickel to copper ratio in the raffinate which is forwarded into the nickel production process is 9.1 t/t.

PM concentrate is extracted using a flotation method from pulp which results from combined flushing of residues from cinder and particulates leaching. Flotation tails are forwarded into a secondary converter matte production process.

Electro-extraction results in marketable copper, M00k grade copper cathodes according to GOST 546-2001.

TABLE

| | Ni/Cu | Direct | Boiling- | | |
|---|---|---|---|---|---|
| | ratio in | copper | down rate | | Market- |
| | solutions | extraction | (amount of | Iron | able |
| | forwarded | into | evaporated | content | copper |
| | to nickel | market- | water), m³ | in | quality, |
| | production | able | per ton of | electro- | GOST |
| Example | process, | product, | marketable | lyte, | 546- |
| No. | t/t | % | copper | g/l | 2001 |
| 1 (closest | 2.8 | 96.7 | 0.98 | 2.4 | M0k |
| prior art) | | | | | |
| 2 | 3.7 | 97.65 | N/A | 1.4 and | M00k |
| (inventive | | | | 0.5 on | |
| method) | | | | edges | |
| 3 | 9.1 | 97.9 | 0.12 | 1.4 and | M00k |
| (inventive | | | | 0.5 on | |
| method) | | | | edges | |

Distinct quantitative characteristics of processing of copper concentrate from flotation separation of converter matte are compared in the Table. It is apparent that, given the same quantitative characteristics of torrefaction and leaching of the same initial material, the claimed method increases the nickel to copper ratio in the solutions which are forwarded into the nickel production process, which explains the increased direct extraction of copper into marketable products. In the claimed method, the iron content in electrolytes from copper electro-extraction baths is reduced, which increases the copper yield to current ratio. The claimed method also reduces the boiling-down ratio, or completely obviates the need for boiling-down. Besides, according to the inventive method, highest grade copper is produced from initial material that is contaminated with impurities.

### Example 4. Implementation of the Inventive Method

Processing of low-iron copper-nickel matte (white matte) produced by smelting in a Vanyukov furnace (VF) and subsequent conversion.

White matte, which has the following composition, %: Cu—72.5; Ni—3.7; Fe—4.0; S—19.3, is torrefied in a fluidized layer (FL) furnace at a temperature of 850°−880° C. in the boiling material layer until the residual sulfur content in the cinder is about 0.1%. After filtering out particulates, torrefaction gases are forwarded into a sulfur acid production process. Torrefaction results in cinder, which has the following composition, %: Cu—72.0; Ni—3.6; Fe—4.0, and fine particulates, which have the following composition, %: Cu—70; Ni—3.6; Fe—3.9, and are sulfur rich up to 2.0%. Fine particulates output is 11.4% of cinder output.

The cinder is leached at a temperature of 70°−80° C. in a circulating solution from the cinder processing line, which is the solution from copper electro-extraction 1, which has the following composition, g/l: Cu—35; H₂SO₄—120. Residue from cinder leaching is condensed and forwarded to water flushing and flotation together with residue from particulates leaching. After postfiltration, bulk of the cinder leaching solution, which has the following composition, g/l: Cu—100; H₂SO₄—15, is sent to copper electro-extraction 1. After postfiltration, a portion of leaching solution in the amount of 0.5 m³ per ton of cathode copper produced in the cinder processing line is sent to vacuum boiling-down and copper sulfate crystallization, which is performed at the temperature of 20° C. Crystallization results in a master solution, which has the following composition, g/l: Cu—42; Ni—26; Fe—2.4; H₂SO₄—21, which is sent to particulates leaching, and copper sulfate crystals, which are dissolved and combined with the solution that is provided to the postfiltration. Baths are supplied with electrolyte which is obtained by homogenization of postfiltration filter liquid and electrolyte which is recovered from the baths. Using current density of 270 A/m²-300 A/m², marketable copper is produced in baths with lead-based alloy anodes. Bath supply solution has the following composition, g/l: Cu—40; Ni—20.0; H₂SO₄—112. Solution in the bath has the following composition, g/l: Cu—35; Ni—20.0; H₂SO₄—120. A part of electrolyte recovered from the baths is mixed with the leaching solution, and another part is returned for cinder leaching. The amount of solution which is sent for boiling-down is determined by the maximum allowable nickel content in the solutions that circulate in the cinder processing lines, which is 20 g/l. As such, iron content in the circulating solutions was 1.8 g/l.

Particulates from torrefaction are leached at a temperature of 70°−80° C. in a portion of raffinate from copper extraction, which has the following composition, g/l: Cu—2; Ni—15; Fe—1.5; H₂SO₄—50, together with the master solution from copper sulfate crystallization. Residue from particulates leaching is condensed and forwarded to water flushing and flotation together with the residue from cinder leaching. Filter liquid from the postfiltration of solution from particulates leaching, which has the following composition, g/l: Cu—32; Ni—15; Fe—1.5; H₂SO₄—3.7, is sent to copper extraction by solvent extraction. The extraction is performed in three stages using a modified oxyoxime based extractant (Acorga M5640 produced by Cytec InD., or its equivalent) in the form of a solution in a carbohydrate diluter, having a 30 vol. % concentration. Raffinate after copper extraction is returned to particulates leaching, and a portion of the raffinate is separated from the copper production process and forwarded into a nickel production process. Copper re-extraction is carried out in two stages using the portion of electrolyte recovered from the baths of separate copper electro-extraction 2. The resulting re-extract, which has the following composition, g/l: Cu—50; Ni—10; Fe—1.0; H₂SO₄—147, is homogenized with a portion of electrolyte recovered from the baths of separate copper electro-extraction 2 and is supplied to the baths of copper electro-extraction 2. Using current density of 270 A/m²-300 A/m², marketable copper is produced in baths with lead-based alloy anodes. Bath supply solution has the following composition, g/l: Cu—40; Ni—10; Fe—1.0; H₂SO₄—162. Part of the electrolyte recovered from the baths, which has the following composition, g/l: Cu—35; Ni—10; Fe—1.0; H₂SO₄—170, is mixed with the re-extract, and another part is returned into copper re-extraction. The marketable copper is produced in baths with lead-based alloy insoluble anodes using a current density of 270 A/m²-300 A/m².

The amount of raffinate to be separated into the nickel production process is determined by consistency of salt content (total sulfates content) in solutions from the particulates processing line. Nickel to copper ratio in the raffinate which is forwarded into the nickel production process is 7.5 t/t.

PM concentrate is extracted using a flotation method from pulp which results from combined flushing of residues from cinder and particulates leaching. Flotation tails are forwarded into a secondary converter matte production process.

Electro-extraction results in marketable copper, M00k grade copper cathodes according to GOST 546-2001. Direct extraction of copper was 97.4%.

### Example 5. Implementation of the Inventive Method

Processing of copper-nickel matte produced by smelting in a Vanyukov furnace (VF).

Copper matte, which has the following composition, %: Cu—58.5; Ni—3.04; Fe—14.2; S—23.2, is torrefied in a fluidized layer (FL) furnace at a temperature of 840°−870° C. in the boiling material layer until the residual sulfur content in the cinder is about 0.5%. After filtering out particulates, torrefaction gases are forwarded into a sulfur acid production process. Torrefaction results in cinder, which has the following composition, %: Cu—60.2; Ni—3.1; Fe—14.6; and fine particulates enriched up to 3.0% sulfur, which have the following composition, %: Cu—61.1; Ni—3.2; Fe—14.9. Fine particulates output is 10.9% of cinder output.

The cinder is leached at a temperature of 70°−80° C. in a circulating solution from the cinder processing line, which is the solution from copper electro-extraction 1, which has the following composition, g/l: Cu—35; H₂SO₄—110. Iron is precipitated from leaching pulp until its residual content is 2.0 g/l by excess cinder while aerating the pulp with oxygen at pH 2.0-2.5. Combined residue from cinder leaching and cleaning out iron is condensed and forwarded to water flushing and flotation together with residue from particulates leaching. After postfiltration, bulk of the cinder leaching solution, which has the following composition, g/l: Cu—97; H₂SO₄—0, is sent to copper electro-extraction 1. After postfiltration, a portion of filter fluid (in the amount of 0.8 M³ per ton of cathode copper produced in the cinder processing line) is sent to vacuum boiling-down and copper sulfate crystallization, which is performed at the temperature of 20° C. Crystallization results in a master solution, which has the following composition, g/l: Cu—40; Ni—2.8; Fe—4.0; H₂SO₄—0, which is sent to particulates leaching, and copper sulfate crystals, which are dissolved and combined with the solution that is provided to the postfiltration. Baths are supplied with electrolyte which is obtained by homogenization of postfiltration filter liquid and electrolyte which is recovered from the baths. Using current density of 270 A/m²-300 A/m², marketable copper is produced in baths with lead-based alloy anodes. Bath supply solution has the following composition, g/l: Cu—40; Ni—15.0; H₂SO₄—102. Solution in the bath has the following composition, g/l: Cu—35; Ni—15.0; H₂SO₄—110. A part of electrolyte recovered from the baths is mixed with the leaching solution, and another part is returned for cinder leaching. The amount of solution sent to boiling-down was 0.8 M³ per ton of marketable copper produced in the cinder processing line. It is determined by the amount of solutions which are generated during the combined flushing of cinder and particulates leaching residues. In this case nickel content in solutions that circulated in the cinder processing line was 15 g/l.

Particulates from torrefaction are leached at a temperature of 70°−80° C. in a portion of raffinate from copper extraction, which has the following composition, g/l: Cu—2; Ni—27; Fe—9.7; H₂SO₄—50, together with the master solution from copper sulfate crystallization. Residue from particulates leaching is condensed and forwarded to water flushing and flotation together with the residue from cinder leaching. Filter liquid from postfiltration of solution from particulates leaching, which has the following composition, g/l: Cu—35.8; Ni—27; Fe—9.7; H₂SO₄—3.5, is sent into copper extraction by solvent extraction. The extraction is performed in three stages using a modified oxyoxime based extractant (Acorga M5640 produced by Cytec InD., or its equivalent) in the form of a solution in a carbohydrate diluter, having a 30 vol. % concentration. Raffinate after copper extraction is returned to particulates leaching, and a portion of the raffinate is separated from the copper production process and forwarded into a nickel production process. Copper re-extraction is carried out in two stages using the portion of electrolyte recovered from the baths of separate copper electro-extraction 2. The resulting re-extract, which has the following composition, g/l: Cu—45.5; Ni—10; Fe—1.0; H₂SO₄—154, is homogenized with a portion of electrolyte recovered from the baths of separate copper electro-extraction 2 and is supplied to the baths of copper electro-extraction 2. Using current density of 270 A/m²-300 A/m², marketable copper is produced in baths with lead-based alloy anodes. Bath supply solution has the following composition, g/l: Cu—40; Ni—10; Fe—1.0; H₂SO₄—162. Part of the electrolyte recovered from the baths, which has the following composition, g/l: Cu—35; Ni—10; Fe—1.0; H₂SO₄—170, is mixed with the re-extract, and another part is returned into copper re-extraction. The marketable copper is produced in baths with lead-based alloy insoluble anodes using a current density of 270 A/m²-300 A/m².

The amount of raffinate to be separated into the nickel production process is determined by consistency of salt content (total sulfates content) in solutions from the particulates processing line. Nickel to copper ratio in the raffinate which is forwarded into the nickel production process was 13.5 t/t.

PM concentrate is extracted using a flotation method from pulp which results from combined flushing of residues from cinder and particulates leaching. Flotation tails are forwarded into a secondary converter matte production process.

Electro-extraction results in marketable copper, M00k grade copper cathodes according to GOST 546-2001. Direct extraction of copper was 94.0%.

Lower extraction is explained by high iron content in the initial material. In the course of cinder and particulates leaching, a portion of copper remains in the leaching residue in the form of dissolution-resistant ferrites which are generated during torrefaction. At the same time, much iron is transferred into the solution, which iron is again precipitated by means of the cinder. As such, an additional amount of cinder copper remains in the insoluble residue.

Thus, the claimed method for processing copper and nickel sulfide materials enables an improvement of performance characteristics of copper and nickel sulfide materials processing, an increase in direct extraction of copper into a marketable product, reduced losses of copper and other valuable components, and a reduced incomplete processing of non-ferrous and precious metals by reducing process cycles.

1. A method of processing copper and nickel sulfide materials, the method comprising: oxidizing torrefaction of a material to obtain cinder and particulates, leaching the cinder with a cycling solution, separating a leaching residue, electro-extraction of copper from a leaching solution, wherein the cinder and particulates generated by the torrefaction are separately leached, wherein the particulates are leached in a cycling copper raffinate together with a separated portion of solution from a cinder processing line, the separated portion including a portion of solution provided to the leaching after electro-extraction of copper; separating a residue from particulate leaching, extracting copper from a solution from particulate leaching by solvent extraction, followed with a separate electro-extraction of copper from a circulating re-extract, then separating a portion of the raffinate to be sent to a nickel production process.

2. The method of claim 1, wherein a master solution from crystallization of a portion of solution from cinder leaching is used as the separated portion of solution from the cinder processing line.

3. The method of claim 1, wherein copper concentrate from flotation separation of converter matte, or nickel containing copper matte, is used as the material of the copper and nickel sulfide materials to be processed.

4. The method of claim 1, wherein white matte is used as the material of the copper and nickel sulfide materials to be processed.
